(19) United States
(12) Patent Application Publication
(10) Pub. No.: US 2006/0200453 A1
(43) Pub. Date: Sep. 7, 2006

(54) Method and system for enterprise data access, annotation and sharing

(75) Inventors: Andrey Santrosyan, San Diego, CA (US); Yingyao Zhou, San Diego, CA (US)

Correspondence Address: GENOMICS INSTITUTE OF THE;NOVARTIS RESEARCH FOUNDATION, 10675 JOHN JAY HOPKINS DRIVE, SUITE E225, SAN DIEGO, CA, 92121-1127, US

(73) Assignee: IRM LLC, Hamilton (BM)

(21) Appl. No.: 11/365,069

(22) Filed: Feb. 28, 2006

Related U.S. Application Data
(60) Provisional application No. 60/658,659, filed on Mar. 1, 2005.

(51) Int. Cl. G06F 17/30

(52) U.S. Cl. 707/3

(57) ABSTRACT

Methods and/or systems allowing flexible, cross-platform data access in enterprise environments and from a variety of different information sources using a convenient interface uses multiple and/or parallel examination of a number of data sources through a client process and return of multiple results that can be modified, cross-referenced or annotated by a user.

### CROSS-REFERENCE TO RELATED APPLICATIONS

This application claims the benefit of U.S. Provisional Application No. 60/658,659, filed Mar. 1, 2005, which application is incorporated herein by reference.

### FIELD OF THE INVENTION

The present invention relates to a method and/or system and/or apparatus allowing easy access to data in enterprise settings, particularly data stored in different formats using different data applications. In specific embodiments, the invention involves one or more logic modules or methods, examples of which are described herein, for easily performing one or more of cross-platform and cross-application data fetching, presentation, compilation, annotation, cross-referencing, reporting and/or updating. In further embodiments, the invention involves one or more methods that may be implemented on a data handling device or system, such as a computer or other information enabled device. In further embodiments, the invention involves one or more methods that facilitate data handling between large data applications and handheld or other portable devices.

### BACKGROUND OF THE INVENTION

Some prior software applications have been proposed to address accessing data over a network from various software applications. U.S. Pat. No. 6,298,158, assigned to Babylon, for example, discusses translating phrases indicated in a software application from one language to another. Other solutions are discussed by Guru Israel, Inc (www.gurunet.com) and in U.S. Pat. Nos. 6,519,631 and 6,341,306. While there has been substantial interest in providing easier access to data stored within enterprises, such as corporations, existing proposals generally fail to provide a combination of features that enable easy use and/or deployment of such systems, particularly in enterprises with a substantial volume and/or variety of data.

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

### SUMMARY OF THE INVENTION

The present invention, in specific embodiment, involves methods and/or systems allowing flexible, cross-platform data access in enterprise environments and from a variety of different information sources using a convenient and easy interface. The invention, in specific embodiments, allows multiple and/or parallel examination of a substantial set of indicated data in a number of data applications and return of multiple results, optionally in a compiled or collected presentation. In specific embodiments, a system of the invention allows users in an enterprise to have easy, fast, and flexible access to some or up to all of the enterprise's internally stored data and in some embodiments also to external data. In further embodiments, the invention allows users to see relationships between data from different sources and to use such data for annotation or other purposes. In some embodiments, access to the enterprise's internal or external data can be directly triggered from within any third-party applications without the need of modifying said third-party application in any way.

According to specific embodiments of the invention, multi-level security and/or access control is built in to the system so that users who are not authorized to see certain sensitive information are not allowed to view such information and/or are not provided an indication that that such information is stored within the enterprise's data storage. In some embodiments, the multi-level security and/or access control can allow control at a database, table, row, record, column, cell, area or object level, even when such control is not provided by a native data application.

According to specific embodiments, the invention operates as follows. A word, a phrase, or any amount of alphanumeric data or other data is indicated or selected at a user's information processing appliance using a client process (which can also be referred to as a thin client, client, or client application). In specific embodiments, this data is referred to as query data (or as a query). Query data, according to specific embodiments of the invention, can include a substantial amount of data that at times is not closely related and that may result in a number of distinct data look-ups or other data services or actions by a relay server.

According to specific embodiments of the invention, the query data is transferred to a relay server (or server). A relay server according to specific embodiments of the invention comprises one or more logic modules and/or information devices operating within an enterprise that has the ability to receive query data from client processes and to determine which data stores and/or applications should be accessed and that further is able to submit or present the query data or a subset to the different data stores or applications. In further embodiments, the relay server receives responses from different database applications and optionally formats and/or compiles and/or further examines those responses to transmit back to a client process. A client process presents an easy to access version of responses for the user and may optionally present further data service options related to the responses.

In various embodiments, responses can be presented by the client process in an auxiliary window, such as an HTML-browser window on a user's display. Presentation can also be in a pop-up or resizable window, on a handheld or other device display, or audibly.

In specific embodiments, responses from multiple different data applications or stores is integrated into a response presentation, allowing a user to easily perceive and/or interact with data from a number of different data sources. For example, in some embodiments, one or more interface indications can include an HTML form and a rich client application. Examples of suitable rich client applications include, for example, an embedded rich client application, a stand-alone rich client, which is native to the data application, and a stand-alone third party rich client, which may or may not be created specifically for accessing the data stored by the data application. In further embodiments, some or all of the presented data contains links, allowing access to more detailed information and/or to underlying data applications or data stores. In further embodiments, some or all of the presented data provides links or other means allowing a user to update or modify the data stored in the underlying data applications.

In further embodiments, a relay server can use stored data about particular users, groups, etc., to determine how to access particular data stores or applications and how to format responses. This stored relay server data can include information about the authenticity of a user, a user's role in the organization, permissions to access particular applications, characteristics of particular information devices, etc.

In further embodiments, a relay server and client process can enable users to make use of data retrieved separately from different data stores. Data from different data stores can be combined by a relay server and client process to automate such tasks as completing order forms. The invention also enables users to make cross-references and annotations of data stored separately in different data sources.

The invention in specific embodiments may be further understood by considering the following example. Assume an enterprise (e.g., a company, a medical institution, an educational institution, etc.) uses three different data storage applications that are relevant for purchase tracking, such as, for example (1) a commercial (e.g., Oracle™-based) finance system with a Win32 client and without a built-in web interface; (2) a Microsoft™-SQL (optionally Web-based) inventory system; and (3) a proprietary web-based procurement system. In many enterprise settings, a user wishing to track an item of data (for example, a purchase order (PO) number) through all three data applications would need to perform three separate searches, possibly using three different search formats. Furthermore, in some situations the user may be required to login or authenticate themselves several times. Furthermore, it is likely that the user will have no easy way to combine the data related to the different searches into one view or report.

According to the present invention, a user with the appropriate authentications can easily access all three data stores. In specific embodiments, all the user needs to do is to indicate query data (for example, a PO number or text including a PO number) to a client process at the user's information appliance. The client process communicates with a relay server that is able to pass appropriate requests based on the query data to various data applications or data stores. The relay server receives responses from the various data applications or stores and transmits responses to the client process for presentation to a user.

An important advantage according to specific preferred embodiments of the present invention is that the invention in most instances does not require modification of underlying data stores, data applications or user interfaces. While some systems have been discussed that either require existing data to be copied into another location or format or that require particular types of database applications, a relay server in specific embodiments uses a plug-in architecture to allow easy deployment using a number of different database applications and/or data services.

Software Implementations

Various embodiments of the present invention provide methods and/or systems for molecular modeling that can be implemented on a general purpose or special purpose information handling appliance using a suitable programming language such as Java, C++, C#, Perl, Cobol, C, Pascal, Fortran, PL1, LISP, assembly, etc., and any suitable data or formatting specifications, such as HTML, XML, dHTML, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

Other Features & Benefits

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims and equivalents.

Furthermore, it is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification.

All references, publications, patents, and patent applications cited herein are hereby incorporated by reference in their entirety for all purposes.

### BRIEF DESCRIPTION OF THE DRAWINGS

FIG. 1 is a block diagram of an example display showing information displayed in a logic application, e.g., an email application running under an operating system (OS), according to specific embodiments of the invention.

FIG. 2 is a block diagram of an example display showing using a client process to indicate data to be searched on a relay server according to specific embodiments of the invention.

FIG. 3 is a block diagram of an example display showing relay server responses according to specific embodiments of the invention.

FIG. 4 is a block diagram of an example display showing relay server responses after selection of a name according to specific embodiments of the invention.

FIG. 5 is a block diagram of an example display showing relay server responses after selection of a compound identification according to specific embodiments of the invention.

FIG. 6 is a block diagram of an example display showing a relay server response display after selection of a compound drawing display according to specific embodiments of the invention.

FIG. 7 is a block diagram of another example display showing relay server search results according to specific embodiments of the invention.

FIG. 8 is a block diagram of an example display showing directory results and indicating user options and functions applicable to specific data stores according to specific embodiments of the invention.

FIG. 9 is a block diagram of an example display showing user options for customizing the search order of different data stores or applications according to specific embodiments of the invention.

FIG. 10A-D are block diagrams example displays showing user configuration options for customizing the operations of a client process and/or for interacting with a relay server according to specific embodiments of the invention.

FIG. 11 is a flowchart of an example method using a client process to indicate query data and using a relay server to obtain responses from multiple data sources according to specific embodiments of the invention.

FIG. 12 is a flowchart of an example method using a client process to indicate query data and using a relay server with plug-ins to obtain responses and provide active links to multiple data sources according to specific embodiments of the invention.

FIG. 13 is a flowchart of an example method using a relay server and plug-ins to analyze query data and determine results according to specific embodiments of the invention.

FIG. 14 is a block diagram showing a representative example logic device in which various aspects of the present invention may be embodied.

### DESCRIPTION OF SPECIFIC EMBODIMENTS

Before describing the present invention in detail, it is to be understood that this invention is not limited to particular compositions or systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content and context clearly dictates otherwise. Thus, for example, reference to “a device” includes a combination of two or more such devices, and the like.

Unless defined otherwise, technical and scientific terms used herein have meanings as commonly understood by one of ordinary skill in the art to which the invention pertains. Although any methods and materials similar or equivalent to those described herein can be used in practice or for testing of the present invention, the preferred materials and methods are described herein.

### 1. OVERVIEW

Large enterprises that use information processing systems are increasingly confronted with enormous amounts of data. Determining whether particular data is already known and/or recorded within a particular information environment; what data may be of any significance; how some data may be related to other data, etc., is becoming an increasingly daunting task. This problem is exacerbated further by the large number of different types of software applications that may contain relevant data. One individual, for example, may keep contacts in a email application, financial data related to one or more of those contacts in a spread-sheet application, records related to those contacts in a database application, and various documents, labels, etc. in one or more different word processing, file system, or image handling applications. In large enterprise environments, such as a large company, education institution, etc., the amount of data and variety of different formats in which the data is kept can be even more formidable.

Some prior software applications have been discussed to address more flexible data accessing. Gurunet Israel (www.gurunet.com), for example, offers a service that provides a user with access to information that Gurunet has collected and/or information available over the World wide web. This information is in some embodiments available by clicking on a word or acronym in a Windows™ application. Gurunet generally includes a large client application installed on each individual's desktop. In an enterprise environment, the Gurunet technology generally utilizes a copy of different databases created specifically for use with Gurunet. Related technology is also described in U.S. Pat. Nos. 6,519,631 and 6,341,306.

More recently, a research services tool is included in some Microsoft™ Office 2003 applications. Descriptions of this tool indicate that it allows users to reference information online, on their computer, or one some intranet databases without leaving an Office application. Users are enabled to insert definitions, stock quotes, and other research information into a document and to customize settings to suit research needs. A research task pane allows users to search multiple sources or select a specific source. Example services indicated available from the research task pane include: (1) dictionary look up of words or phrases; (2) adding other dictionaries; (3) thesaurus look up; (4) encyclopedia search; (5) translations; (6) stock quotes and company information look ups; (7) custom actions and smart tags, where smart tags include data recognized and labeled as a particular type—for example, a person's name or e-mail address labeled with a smart tag; (8) adding third-party content in a list of research services; (9) presenting the most relevant information based on search scope and question; (10) searching the web using MSN Search; and (11) accessing intranet sites that support Microsoft Office SharePoint Portal Server 2003.

### 2. EXAMPLE USER EXPERIENCES ACCORDING TO THE INVENTION

The present invention is designed primarily to provide enterprise-wide access to data stored in an enterprise's information environment as well as to provide access to various data-relates services, like data analysis or graphical display. Unlike some earlier approaches, the user experience and technology is designed primarily to allow a user to interact with all in-company data for which the user is authorized, using the native data applications and primary database stores, but with an integrated and easy user interface. The architectural and user interface features of the invention are designed to allow easy deployment in various enterprise environments and easy adaptations to connect with various data applications. As an optional feature, specific embodiments can also provide access to some publicly available information.

Key aspects of embodiments of the present invention may be understood from example user interface experiences according to specific embodiments of the invention. Specific embodiments of the present invention provide a user experience as illustrated in one or more of the following example graphical screen displays. It will be understood to those of skill in the art that many different implementations of a software system can provide the functionality as described by these screen interfaces and thus these novel aspects according to specific embodiments of the invention are not limited to specific software and/or hardware architectures or implementations. Conversely, it will be apparent that many different specific interface implementations are possible in accordance with the teachings of the present invention, including screen interfaces that have a very different appearance to these examples (for example, using different graphical designs, languages, arrangements of parts, etc.) as well as user interfaces designed for different types of displays (for example, telephone displays, PDA displays, handheld and/or pen computers, etc.), as well as interfaces that have no visual display, but rely on audio interaction with a user. Thus, the invention should not be seen as limited by the example graphical displays shown.

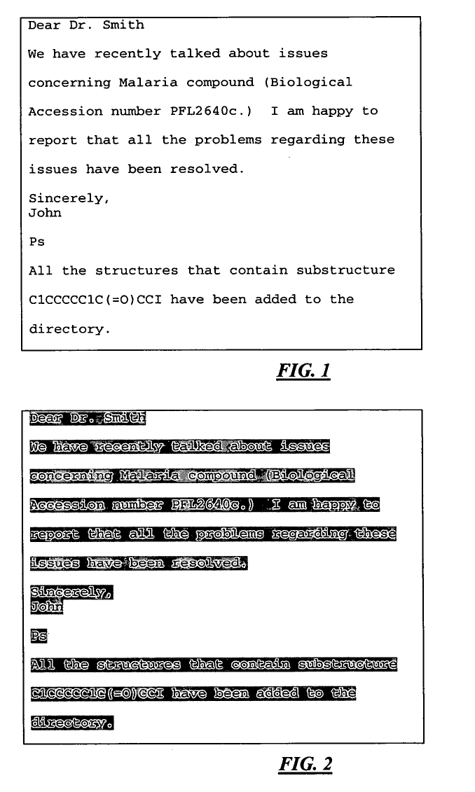

FIG. 1 is a block diagram of an example display showing information displayed in a logic application, e.g., an email application running under an operating system (OS), according to specific embodiments of the invention. In this example, a simple email message is shown, which could be displayed in any number of email applications or could be presented in audio form to a user. Note that in this initial display, the data displayed is simple alphanumeric text data, separated by spaces and other punctuation, and does not in this case have underlying formatting or tagging associated with it.

According to specific embodiments of the invention, a user can indicate using a client process some and/or up to all of the displayed data for analysis by a relay server. In a particular example, FIG. 2 illustrates a user indicating all of the alphanumeric text in an email message. Indication may be enabled by a client process for example by using a mouse or other pointing device, by using one or more keystroke commands, by using a spoken command, etc. A user may indicate some or all of the presented data for passing by the client process to a relay server. Alternatively, a client process according to specific embodiments of the invention can automatically upon presentation of particular data (such as every email message, or email messages flagged according to subject, sender, key word, etc.) transmit some or all of the presented data to a relay server for analysis.

While FIG. 2 shows selection of displayed text using a graphical pointing device, alternatively, a user could use a spoken command, e.g. “select all,” “search all,” “search numbers,” “search PO's,” “search chemicals,” “display formulas,” “search names,” etc. Recognition of various spoken commands and training of spoke commands can be provided by a client process in various implementations as will be understood in the art.

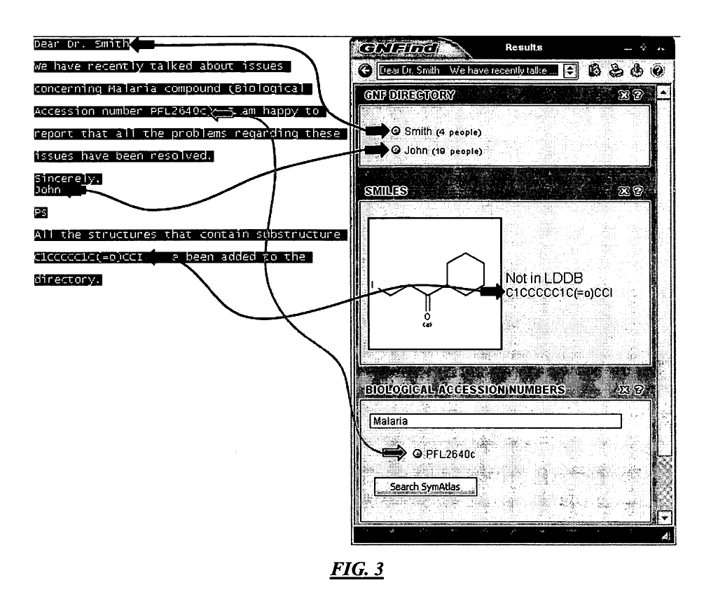

FIG. 3 is a block diagram of an example display showing relay server responses according to specific embodiments of the invention. In this example, two data stores (which can also be referred to as dictionaries or /databases) and one data application provide results.

In the upper right portion, words in the email message are compared against a company name directory (e.g., the “GNF directory”). In this example, two words “John” and “Smith” are found in the directory, with 4 record hits for “Smith” and 19 for “John.” In this example, these hits are displayed using a hyperlink, indicated by the blue text, that allows a user to select that link to retrieve more information about specific found records.

In the lower right portion, all of the words in the email message are compared against an enterprise laboratory database (e.g., a “Biological Accession Numbers” database). In this example, one phrase “PFL2640c” is found in the database. In this example, this phrase is displayed using a hyperlink that allows a user to select that link to retrieve more information about the specific found record. The “Search SymAtlas” button in this sub-window provides further functions related to the “Biological Accession Numbers” data.

In the middle right portion, a different type of result is shown. In this case, the relay search engine is further enabled to recognize alphanumeric text that can be represented by some type of processing that is not a search in a data store. In this example, the data service provides a graphical representation of certain chemical formulae. In the present example, the formula C1CCCCC1C(=o)CC1 is recognized as one that can be displayed graphically by a service available through the relay server (referred to in this example as SMILES), and that graphical display is presented. The graphical record is presented as a hyperlink allowing a user to select it to get further service-related analysis about the formula. The relay server further indicates that the formula was one that was recognized as being possibly relevant to a laboratory database (e.g., a database referred to as LDDB). This recognition can be based on rules such as regular expressions that recognize query data as being of a format that is possibly relevant to a particular data store or application. In this example, the chemical formula was recognized as being possibly relevant to a laboratory database, but when a search was performed, no matching records were found.

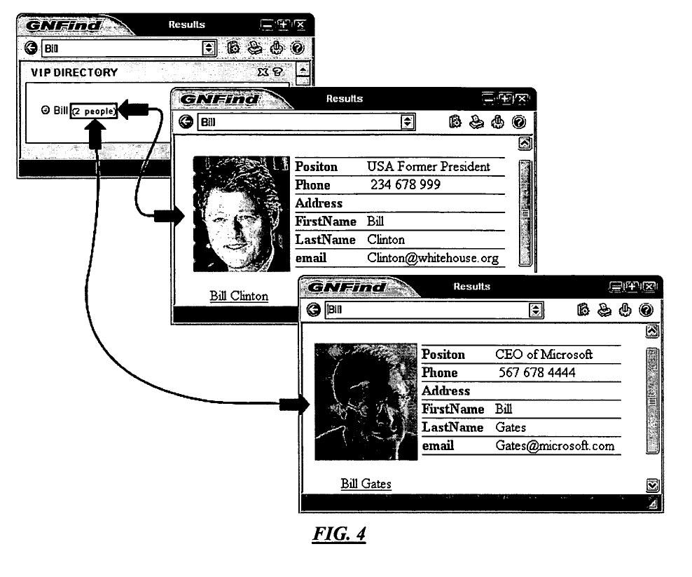

FIG. 4 is a block diagram of an example display showing relay server responses after selection of a name according to specific embodiments of the invention. In this drawing, example displays are shown for two different name selections. In the two cases, the presented data after selection of a name is essentially a record from a company directory type database. In this example, the name is highlighted indicating a hyperlink that can provide additional functions, such as sending an email, dialing a phone number, or opening a database entry allowing a user to update the data. In further embodiments, selection of a displayed field allows a user to modify that field if the user has permissions. The authorized and modified data is then returned, generally via the relay server, to the original data application. Further authentication checks may be made at the relay server or the data application and the data is modified if the user is authorized.

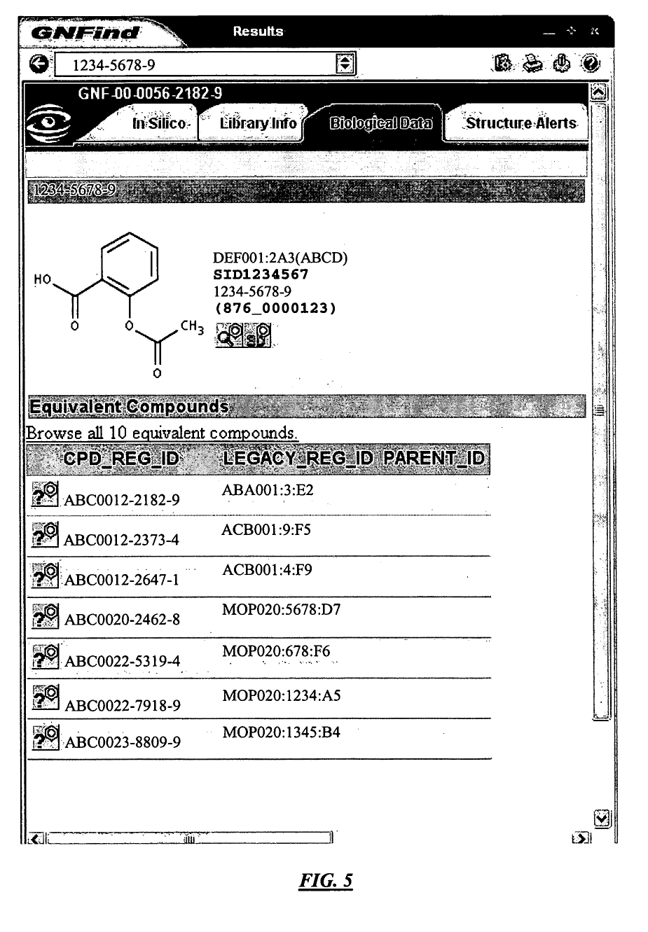

FIG. 5 is a block diagram of an example display showing relay server responses after selection of a compound identification according to specific embodiments of the invention. In this example, a number of different options are provided for accessing and/or modifying information relating to the compound. The upper left tab (In Silico), allows a user to access assay results, other data, analysis, etc., related to computer-based examination, experimentation, charactizations, etc. of the compound. The next tab (Library Info), allows a user to access any reference or library data stored regarding the compound. The Biological Data tab, which is displayed in this case, shows a 2D representation of the compound to the left, provides a link allowing activation of a 3D display of the compound, and at the bottom allows linkages to other equivalent compounds. The Structure Alerts tab at the right, indicates results of analysis or other data related to the structure of the compound. While these options are just examples, according to specific embodiments of the invention they all provide access to various enterprise data through a simple client interface.

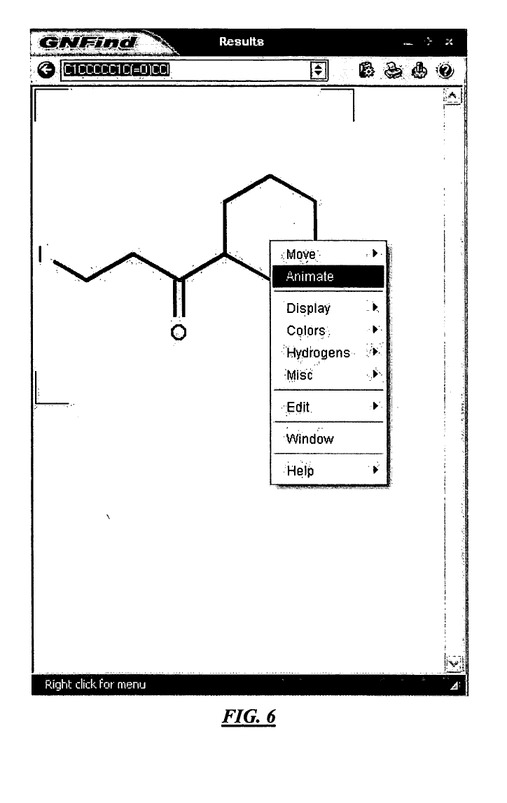

FIG. 6 is a block diagram of an example display showing a relay server response display after selection of a compound drawing display according to specific embodiments of the invention. In this example, the reply report returned includes an active drawing of a chemical formula and provides controls for varying display options, such as changing colors, displaying hydrogen atoms, etc. Other services can also be provided by a relay server that are not essentially a look up in a dictionary or data store.

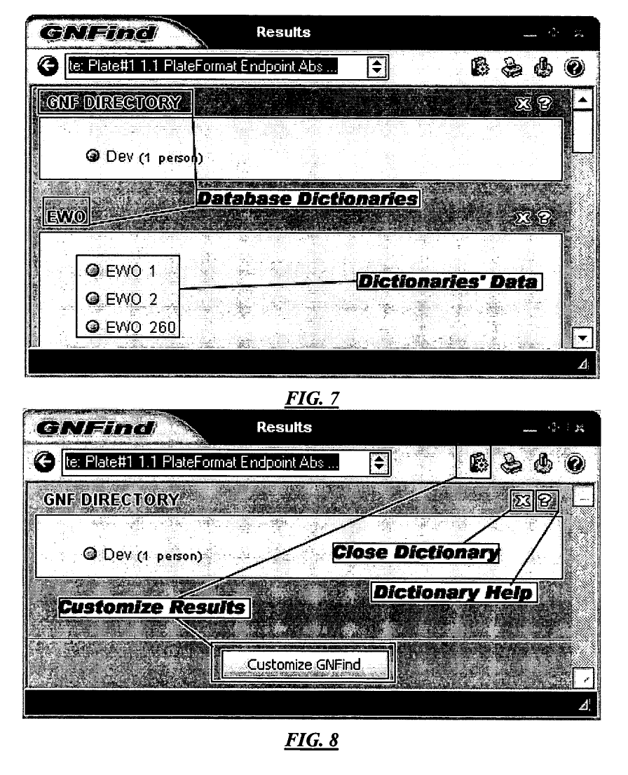

FIG. 7 is a block diagram of another example display showing relay server search results according to specific embodiments of the invention. In this example, the client process displays query data responses from two data stores. The Directory sub-window shows responses from a data service that searches for names. The EWO sub-window (Engineering Work Order) displays responses from a relay server from a data store of work order numbers. FIG. 8 is a block diagram of an example display showing directory results and indicating user options and functions applicable to specific data stores according to specific embodiments of the invention.

In these example figures, the display shows a query data field at the top, indicating the query data that the responses relay to. Each sub-window includes an “X” indication for closing that sub-window, and a “?” indication for getting help related to that sub-window and/or the data store or application that provided the results.

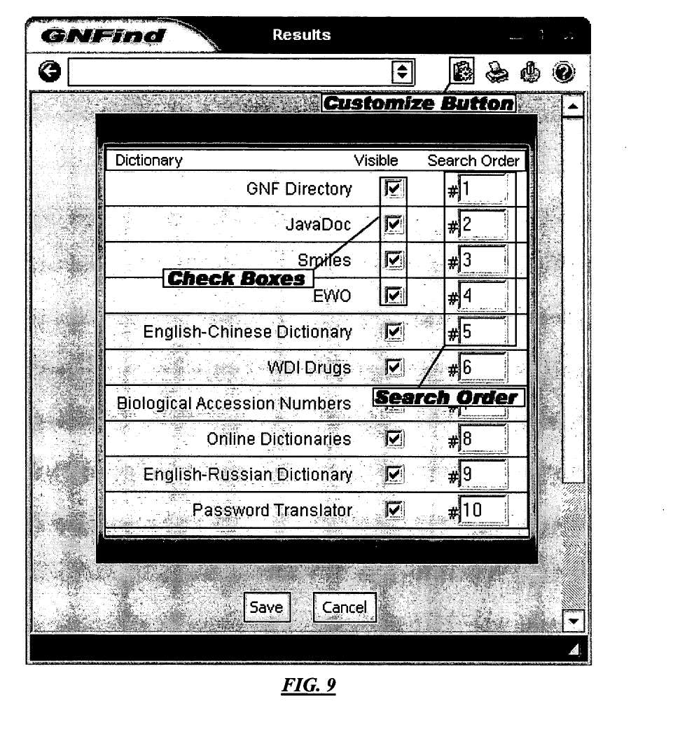

FIG. 9 is a block diagram of an example display showing user options for customizing the search order of different data stores or applications according to specific embodiments of the invention. In this example, ten total data store or data applications are available for display and a check box allows indication of whether or not to visibly access each particular data store or service. A search order field allows users to indicate an order in which query data is passed to different data services and/or in which responses are displayed. In this example embodiment, active data stores are displayed sequentially according to their ranks specified by the search order column, in this example allowing fractional values to be entered. For instance, an order number 2.5 will place a data store in between ranks 2 and 3.

In other embodiments, the ordering of dictionary results may be dynamic and may be indicated by the Client or Relay Server based on a determination of a likely relevance of particular results.

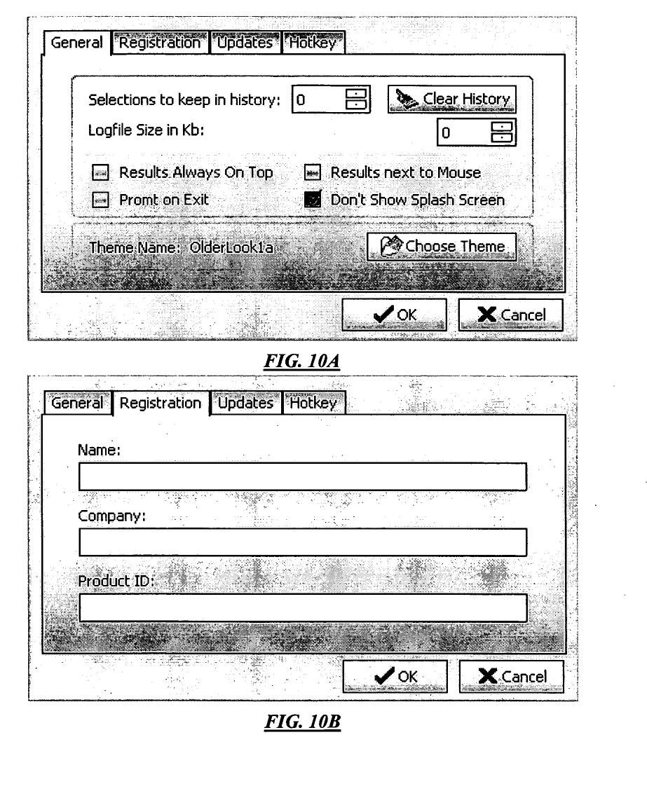

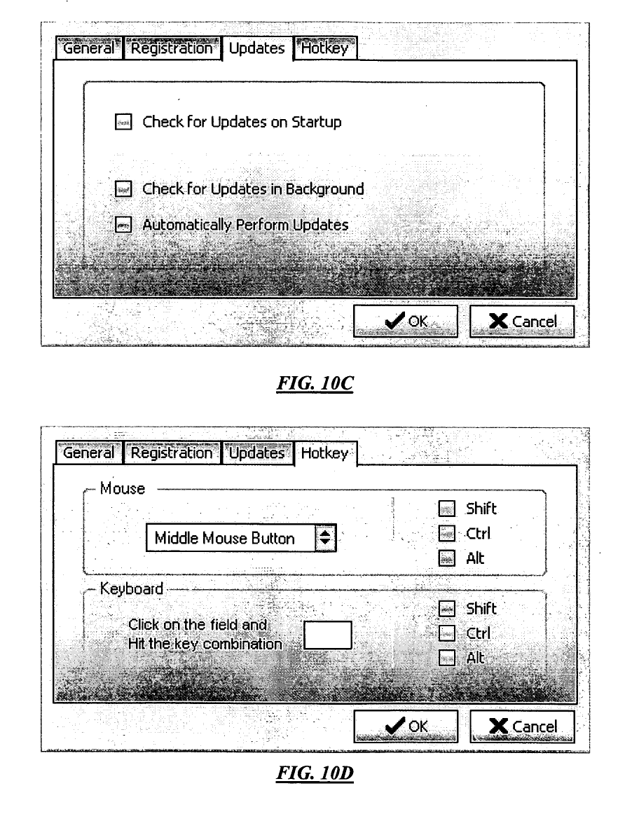

FIG. 10A-D are block diagrams example displays showing user configuration options for customizing the operations of a client process and/or for interacting with a relay server according to specific embodiments of the invention. Features provided for customization will vary according to specific embodiments of the invention. In this example, in FIG. 10A, a field is provided that allows a user to specify the history of searches that should be stored and allows a user to clear the history. A further field is provided allowing a user to indicate a size of a log file. Display options allow a user to indicate that the response window is always on top, and to select options regarding window placement, etc. In FIG. 10B, a user enters registration information. In FIG. 10C, a user can specify update options. In FIG. 10D, keyboard and mouse hotkey settings allow a user to customize how their keyboard and mouse interacts with the client application.

### 3. EXAMPLE METHODS

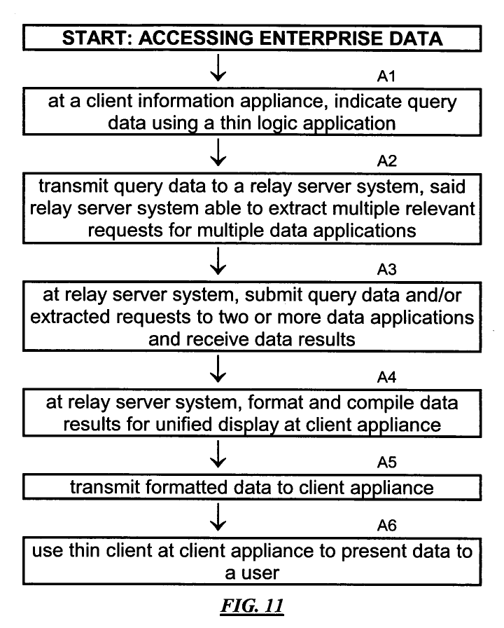

The invention can be further understood as involving one or more methods allowing users to interact with various data sources using a client process and relay server executing on computing devices according to specific embodiments of the invention. FIG. 11 is a flowchart of an example method using a client process to indicate query data and using a relay server to obtain responses from multiple data sources according to specific embodiments of the invention.

According to one example method, at a client information appliance, a user indicates query data using a thin client logic process (Step A1). The data is then transmitted to a relay server system able to extract one or more requests for one or more data sources or data applications (Step A2). The relay server system submit requests optionally including processed and/or raw query data to one or more enterprise data sources and receive data results (Step A3). The relay server can optionally format data responses from data sources (Step A4) and then transmit the responses back to the client process (Step A5). The client process presents the response data to the user (Step A6).

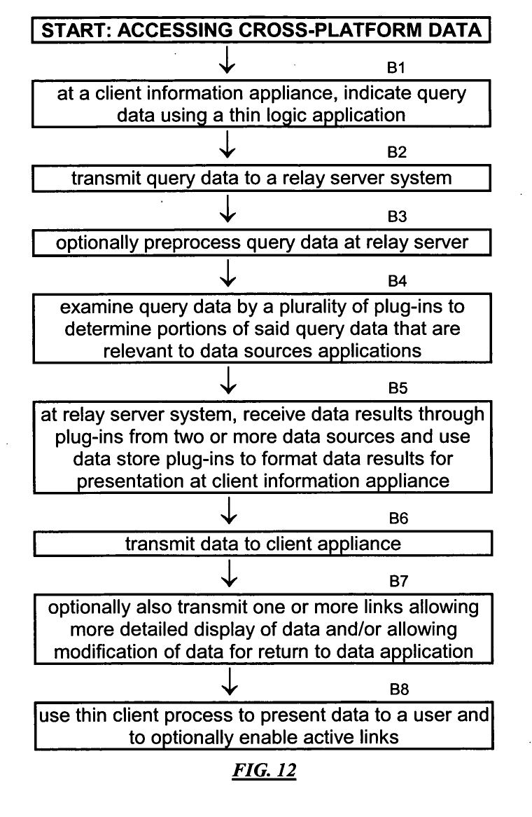

FIG. 12 is a flowchart of an example method using a client process to indicate query data and using a relay server with plug-ins to obtain responses and provide active links to multiple data sources according to specific embodiments of the invention. According to another example method, at a client information appliance, query data is indicated using a client process (Step B1). The query data is optionally preprocessed at a relay server (Step B2) and then examined by a plurality of plug-ins to determine portions of said query data that are relevant enterprise data sources (Step B3). The plug-ins are then used to submit query data and/or extracted requests to two or more enterprise data applications and to receive data results, where in some situations the requests may be essentially unrelated as far as the two data applications are concerned, such as a name and a PO number (Step B4). At relay server system, the data results are formatted for unified display at client appliance (Step B5) and then the formatted data is transmitted to a client process (Step B6) which presents the data for viewing and/or modification to a user (Step B7).

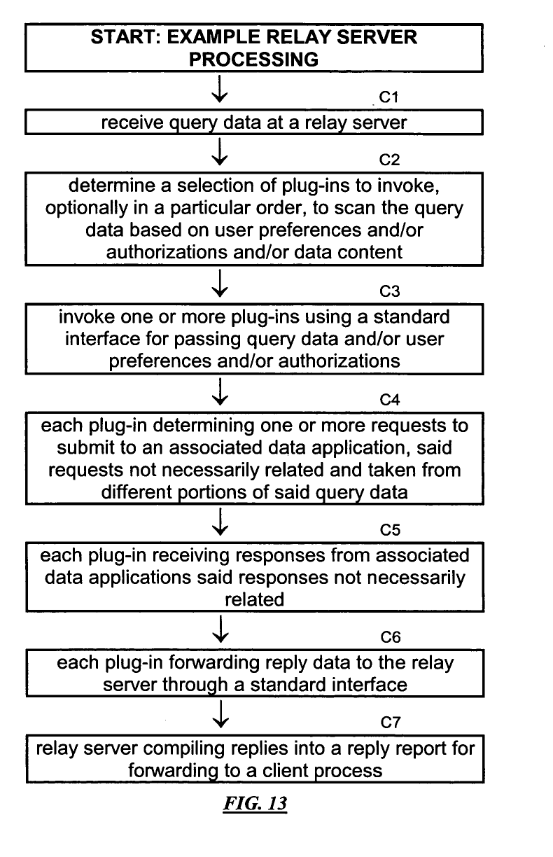

FIG. 13 is a flowchart of an example method using a relay server and plug-ins to analyze query data and determine results according to specific embodiments of the invention. In this example, query data is received at a relay server (Step C1). The relay server determines a selection of plug-ins to invoke, optionally in a particular order, to scan the query data based on user preferences and/or authorizations and/or data content (Step C2) and invokes one or more plug-ins using a standard interface for passing query data and/or user preferences and/or authorizations (Step C3). Once invoked, each plug-in determines one or more requests to submit to an associated data application where the requests are not necessarily related to one another and taken from different portions of said query data (Step C4). For example, a Name Directory Plug-in might identify six different words from several different parts of the query data as possible names and submit essentially six separate requests to a Name Directory Data Application. These names may be only tangentially related, or not related at all. Likewise, a Chemical Formula Plug-in might identify four entirely different parts of the query data that may be Chemical identifiers and might submit four requests to a Chemical Database Application and the same four requests also to a Chemical Graphical Application. Each plug-in receives responses from associated data applications where the responses not necessarily related (Step C5) and each plug-in uses a standard interface to forward the response data to the relay server (Step C6). The relay server compiles the response data into a reply report for forwarding to a client process (Step C7).

### 4. EXAMPLE SYSTEM ARCHITECTURE

According to specific embodiments, the invention can be understood as consisting of a number of instances of a client process or application (client processes) and a server process, application, or system (the relay server). As discussed above, in specific embodiments, the client process extracts a portion of text or other data from virtually any application in any compatible operating system (such as Windows™ or Linux™) either automatically or in response to a user action. The client then transmits the extracted query data (optionally, along with user authentication information and other information) to the relay server and presents responses received from the relay server. The relay server validates a user's authentication and analyses the submitted query data.

Relay Server

In a preferred embodiment, analysis of the query data is performed at the relay server. In specific embodiments, a relay server uses a combination of recognition methods to identify words, phrases, and/or other data that may be meaningful to one or more available enterprise data sources. Query data items may then be associated with one or more data results by submitting one or more requests to one or more data source applications. These data applications may be executing on the same hardware as the relay server, but often may also be executing on separate hardware, which is connected to the relay server by a communication network. The relay server may partially format results received from data applications (for example, using HTML format) and forwards them to a client for presentation to a user.

Thus, a relay server according to specific embodiments of the invention functions to relay requests to various data sources. In specific embodiments, a relay server works with a number of relay server plug-ins to provide quick and easy way of looking up words, phrases, numerical fields, or other data from one or more different data sources. A relay server according to specific embodiments of the invention allows users to easily access and integrate many different data sources in an enterprise environment, such as one or more of: (1) existing web-based intranet infrastructure; (2) various enterprise databases without web interface; and (3) other enterprise data. In a particular embodiment, a relay server can be implemented based on, for example, J2EE and deployed on, for example, a Tomcat Application Server.

In specific embodiments, a relay server further can be understood as comprising a Main Processing Unit (MPU) and a set of plug-ins. In particular embodiments, the MPU performs such tasks as receiving requests from client processes, performing basic pre-processing (e.g., removing duplicates, ordering, etc), validating a user's identity, loading user's preferences, etc. It may then determine an ordered list of plug-ins and invoke each plug-in and pass requests to the plug-ins.

Plug-Ins

Plug-Ins in the context of the present invention indicate logic modules or portions of software that have a similar general function, but are adapted or customized to perform specific instances of the general function. According to specific embodiments of the invention, one or more plug-ins are responsible for performing searches and/or for formatting a reply in communication with different data applications. According to specific embodiments of the invention, each plug-in implements a plug-in interface (e.g., an API) that allows the relay server to easily interact with it. This architecture, according to specific embodiments of the invention, greatly eases the integration of a relay server with various existing data applications in an enterprise. Plug-ins are more easily developed at the enterprise level to accommodate proprietary data stores or services or to accommodate changes in data stores, security models, or other functions.

Plug-ins, according to specific embodiments of the invention, provide logic instructions that enable one or more of the following functions: (1) analyze a regular expression or other pattern to determine whether to use the plug-in for a particular query; (2) return a name of the plug-in; (3) accept query data; (4) accept authentication information; (5) extract multiple relevant data application requests from a set of query data; (6) return a number of matches; (7) return a formatted or partially formatted reply (e.g., in HTML); (8) cache matching queries; and (9) other functions that will be understood from the teachings herein.

As with other logic modules of the invention, plug-ins can be written in any programming language. In specific implementations, plug-ins can be either relay server-local classes, or remote applications accessible through Web Services or other interfaces. According to specific embodiments of the invention, plug-ins are registered with the server. In some embodiments, the server may have information about which users can access each plug-in, thus providing one level of security. The plug-in can further differentiate its results using internal logic and authentication information. In one example implementation, more than a dozen plug-ins have been developed for various data sources.

In further specific embodiments, after analyzing the query, user's permissions, preferences, and other data, the relay server determines an ordered list of plug-ins. A pre-processed query and/or the original query is transferred or otherwise made available to each individual plug-in. Each plug-in performs its own specific analysis of the query, and, if any hits are found, returns them to the relay server using a standard interface. The relay server can organize the results into a single compiled report (e.g., an HTML page) and return the results to the client process.

In further specific embodiments, plug-ins can be understood as being of three basic types as discussed below. In specific implementations, some Plug-ins are a combination of two or three types.

Definitive Plug-In

A Plug-in is referred to as definitive if it is able to always return guaranteed hits. For example, a Directory Plug-in might return a word as a hit if and only if that word is a first name, a last name, or a username of an employee of the company. The precision of a definitive plug-in can be achieved in a number of ways: by caching the whole list of possible hits, by looking up every hit in a database, by validating the query against a set of rules, etc. Definitive plug-ins are generally used when the total number of possible hits is relatively small and/or when the hits are not easily described using regular expressions.

Guessing Plug-In

A guessing Plug-in according to specific embodiments of the invention are those that do not always affirmatively define whether a particular word or phrase is a hit, but decide to return a hit based on an “educated guess”. For example, any string that has a format PO+a letter+four numbers is likely to be a PO number in a company that uses that format for PO numbers.

Other guessing plug-ins may be those that do not return a database entry, but some other type of information, for example a Compound Structure Plug-in, which attempts to construct a chemical structure object by interpreting parts of query as SMILES strings whenever a likely SMILES string is detected.

Thus, with a guessing Plug-in, a hit returned might be a false hit (e.g., there might be no actual PO with number POZ1234 or the SMILES result might be based on characters that are not actually intended to be a SMILES string.). The advantage is that it generally can return a result much faster and generally does not require memory for caching. In specific embodiments, guessing plug-ins can use regular expressions, pre-cached additional information (like the maximal PO number in the database), or other information that can be gained from the query. Guessing Plug-ins may be used when the total number of possible hits is huge to indefinite and/or when a likely hit can be extracted from the query itself. Guessing plug-ins are also useful when it is likely that a part of the query data is relevant to a particular data source, but may not be stored or known in that data application. For example, POZ1234 might be a valid or new PO number that is not already stored in one or more relevant data source. A guessing Plug-in, by returning a “hit” on that data though indicating the data is not yet stored in a relevant database, can alert a user that the data should be added to one or more relevant databases. In further embodiments, as discussed herein, the responses presented to a user by a client process can provide a link or other means for an authorized user to enter the guessed hit to be entered as a record in one or more relevant databases.

Passing Plug-In

Passing plug-ins typically attempt to transfer a query or pre-processed query to a data source or application or third party without trying to understand it or extract individual hits from it. Examples are translators, dictionary lookups or other search engine connectors. Passing plug-ins according to specific embodiments of the invention can be used or understood as shortcuts to web-based services that typically do not provide sophisticated feedback to a relay server. Essentially any web-based application can be connected to a relay server according to specific embodiments of the invention by using a passing Plug-in.

Preprocessing of Query Data

According to specific embodiments of the invention, query data is generally pre-processed at the relay server prior to or as it is being made available to the plug-ins. In specific embodiments, Plug-ins generally have access to both pre-processed and raw query data. In specific embodiments, the pre-processor on the relay server can be guided by the presence of multiple specific plug-ins that may require complicated pre-processing, the results of which can be shared. For example, if there are three plug-ins that rely on molecular objects, those objects are created in the pre-processor and every plug-in has access to those objects. This type of pre-processing allows the relay server and plug-ins to return results often in under 15 milliseconds.

### 5. ANNOTATION AND CROSS-REFERENCING

According to further specific embodiments, the invention can support two types of annotation using plug-ins. In one instance, when the plug-in is specifically written for the purpose of interacting with other plug-in results, and in another instance when the annotation is applied to any plug-in.

As a usage example, consider that many vendors receive orders from various customers by email. The sender of the email is typically someone from the purchasing department of the client. The email typically contains such data as part numbers and quantities desired.

Assume an example where a vendor V uses a web-based internal application (referred to herein as WEBAPP) for filling orders, and uses a separate database of client information (referred to herein as CLIENTDB, containing names, account numbers, terms and other client data. In a typical situation and without using the present invention, an employee of V would lookup the account number of the client in CLIENTDB, launch WEBAPP, and copy/paste account number and part numbers into a form FORM of WEBAPP. The employee is likely to have to log into both CLIENTDB and WEBAPP to get access to the data.

According to specific embodiments of the invention, two plug-ins are made available to simplify the process: A lookup plug-in (P1) that returns client account number looked up by name or email address of the buyer, and an interactive plug-in (P2) that recognizes part numbers and provide a pre-filled copy of FORM. According to specific embodiments of the invention, the vendor employee highlights the entire email message, invokes the invention client process and the invention displays a result containing a pre-filled FORM and (separately) client account number. The employee then can drag-and-drop the account number into the FORM, fill in quantities and submit the FORM.

Thus, in this embodiment of the present invention, the relay server does not exclusively consist of independent data sources. Instead, one data source can take into account the results that other data sources have returned and furthermore, the relay server or one or more plug-ins can combine data from different sources to complete a task. Thus, in this example, one plug-in recognizes email addresses, another plug-in recognizes account numbers and the fact that both work together allows a system according to specific embodiments of the invention to generate a pre-filled form.

In further embodiments, the Relay Server can be configured to record all transactions involving two or more plug-ins (e.g., P1 and P2)_ in a separate or a related data store, thus collecting statistics that are not necessarily available in WEBAPP or CLIENTDB.

As a further example, consider a scientific institution that has two plug-ins: P1, which recognizes scientists and P2, which recognizes gene names. In this instance, an employee can highlight text of an entire scientific publication and invoke the invention and two lists will be returned: (1) a list of all internal scientists mentioned in the article and (2) a list of all genes mentioned in the article. The employee then can link one or more scientists to one or more genes by a simple drag and drop operation. Optionally, the employee can also type in annotation, for example “Dr. Smith has some expertise with this gene as it applies to heart disease”. In this case, the next time someone from the institution accesses the same gene(s), the names of the experts will also be returned by the invention.

In specific embodiments, these plug-ins are not written to be used together or to make the linkages automatically, but instead allow the user to make the linkage and store the linkage optionally in a separate data store associated with the invention. Each user can store linkages for himself alone or make them available for larger groups or all users of the system.

In specific embodiments, the client process allows a user to annotate the results the user receives. Annotations can include such things as links between data items that are not otherwise indicated as related, such as linking a pair of results, for example a particular person in a name directory and a chemical compound they are working on, or a gene and a compound. Creating such external links, which are preferably stored at the Relay Server, allows connections between data records that may be stored in entirely different data applications. Annotations can also include things such as comments related to particular records that are not stored in the native data application.

### 6. CLIENT

According to specific example embodiments, a client process is a Windows-based application able to extract selected text or other data from virtually any application compatible with Windows (e.g., Win32), send it over HTTP or HTTPS to a specified relay, and present a results report (e.g., in HTML format) received from the relay server in a browser window. In specific embodiments, a client process according to the invention is able to extract any amount of indicated text or other data from an application window and is able to work with virtually any Win32 application, including but not limited to MS Office applications, any internet browser, Adobe Reader, Lotus Notes, etc. Extraction can be invoked by a mouse click, keyboard shortcut, a combination of both (e.g. Ctrl+Right Click), a spoken command, or any other device or method provided for a user to interact with an information system. In some embodiments, various interaction options are configurable by the end user. In specific embodiments, the Client operates in such a way as to preserve the original contents of Windows Clipboard and does not interfere with the normal work of other applications (except when a conflicting keyboard shortcut is used).

In a further specific example embodiment, a client according to the invention sends a POST request to an URL (that generally can be configured and changed at any time). Communication can be through any supported format, such as HTTP or HTTPS, and can be done directly or through a proxy server. In specific embodiments, the client can transfer the text of a selection, along with information about the application it was invoked on, and any additional pre-determined text information.

Presentation of results can be through any convenient or available user presentation method, including visual or audio. An example embodiment uses an HTML-type browser to display the result report and that supports generally all features supported by Microsoft Internet Explorer, including features such as applets, Flash plug-ins, CSS, JavaScript etc. Generally, when the browser window is closed (the “X” button clicked), the window disappears, but the process remains active, so that all session cookies remain active.

In specific embodiment, a client logic is specified using Borland Delphi and is designed to operate with a Microsoft Windows™ operating system. Other operating systems, such as Linux or Apple Mac OS can also be supported.

In further embodiments, a client process and/or relay server is enabled to provide interactive access to data stored in data applications. Interactive access allows authorized users to modify data and/or add data to data applications. In some embodiments, this is accomplished by providing a link that may access a data application more directly. In other embodiments, modified data is returned by the client to the Relay Server and the Relay Server handles making the modification at the data application.

### 7. AUTHENTICATION SECURITY MODEL AND PERSONALIZATION

According to specific embodiments of the invention, a relay server further includes enterprise-wide authentication and/or authorization mechanisms, that allow it to fully control access permissions so that users only see or are aware of data that they are authorized to view and/or are only allowed to modify data that they are authorized to modify.

In various specific implementations, a relay server according to the invention can have user authentication data store and/or it can be connected to a corporate repository such as Active Directory™ (AD). Similarly, authentication according to specific embodiments of the invention can be performed by built-in mechanisms within the relay server, or by using corporate services like Kerberos™, or by a combination of the two when appropriate. For example, a relay server can determine the authorization level of the user using both external (AD groups) and internal structures. For an authorized user, the server builds a list of allowed plug-ins and engages them. Each plug-in, in turn, can have access to user's information and can filter responses from the plug-in accordingly.

According to specific embodiments of the invention, together with permission information, user's preferences are retrieved from a data store. Preferences include the plug-ins user is most interested in, their order and priority, as well as some customization.

In specific embodiments, a client process supports all common authentication mechanisms that work over HTTP/HTTPS protocols. The relay server can provide authentication against Active Directory or any directory supporting LDAP and can include its own optional authentication database. As a result of the authentication process the relay server obtains verified unique user identified (userID) that can be passed to the plug-ins. A user can be member of one or more groups. Groups can also be members of other groups. Again, either a directory or the internal database can be used to store and retrieve this information

As a further security measure, each plug-in has a list of groups that are allowed to access it. If the list of allowed groups for the plug-in and the list of all groups the user is a member of contain at least one common entry, the access is granted. The userID along with the group list is passed to the plug-in through the standard interface. Furthermore, for each plug-in the user roles can be optionally defined. Each role can be granted or denied access to each uniquely identifiable piece of data, and the permissions information is stored in a database or directory external to the native application. Each group can have one or more roles in each plug-in. The framework passes the user/group/roles data to a plug-in, and makes any saved permissions information available to the plug-in. It is up to the plug-in to interpret provided information.

### 8. EMBODIMENT IN A PROGRAMMED INFORMATION APPLIANCE

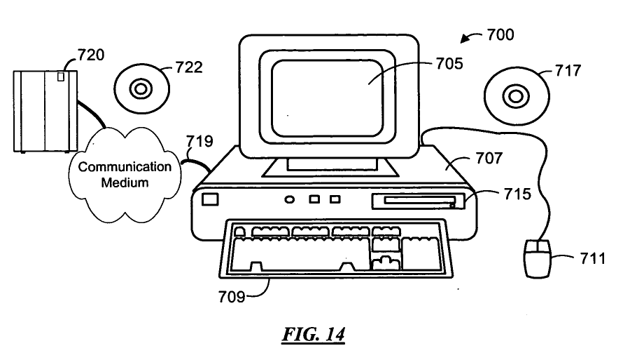

FIG. 14 is a block diagram showing a representative example logic device in which various aspects of the present invention may be embodied. As will be understood to practitioners in the art from the teachings provided herein, the invention can be implemented in hardware and/or software. In some embodiments of the invention, different aspects of the invention can be implemented in either client-side logic or server-side logic. As will be understood in the art, the invention or components thereof may be embodied in a fixed media program component containing logic instructions and/or data that when loaded into an appropriately configured computing device cause that device to perform according to the invention. As will be understood in the art, a fixed media containing logic instructions may be delivered to a user on a fixed media for physically loading into a user's computer or a fixed media containing logic instructions may reside on a remote server that a user accesses through a communication medium in order to download a program component.

FIG. 14 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection.

The illustrated information system 700, can also represent various types of special purpose, information enabled, systems, such as scientific or laboratory systems that include information handling capabilities. Such systems can include robotic sample handling systems or other capabilities in addition to any information processing capabilities.

The invention also may be embodied in whole or in part within the circuitry of an application specific integrated circuit (ASIC) or a programmable logic device (PLD). In such a case, the invention may be embodied in a computer understandable descriptor language, which may be used to create an ASIC, or PLD that operates as herein described.

### 9. OTHER EMBODIMENTS

The invention has now been described with reference to specific embodiments. Other embodiments will be apparent to those of skill in the art. In particular, a user digital information appliance has generally been illustrated as a personal computer. However, the digital computing device is meant to be any information appliance for performing numerical analysis and can include such devices as a personal digital assistant, scientific workstation, laboratory or manufacturing equipment, etc. It is understood that the examples and embodiments described herein are for illustrative purposes and that various modifications or changes in light thereof will be suggested by the teachings herein to persons skilled in the art and are to be included within the spirit and purview of this application and scope of the claims.

All publications, patents, and patent applications cited herein or filed with this application, including any references filed as part of an Information Disclosure Statement, are incorporated by reference in their entirety.

What is claimed:

1. A method allowing a user to interact with cross-application data in an enterprise setting using an information appliance comprising:
indicating query data from an application executing on a user's information appliance using a client process on said information appliance;
transmitting said query data over a communication medium to a relay server;
analyzing query data to determine one or more data application requests to send to one or more data applications;
transmitting one or more data application requests to selected one or more data applications to retrieve desired data using said relay server;
receiving at said relay server data application responses to said data application requests;
at said relay server, transmitting results using said data application responses to said information appliance; and
presenting said results.

2. The method of claim 1 further wherein:
compiling at said relay server said data application responses into a results report;
transmitting said results report to said information appliance; and
presenting said results report.

3. The method of claim 1 further wherein:
said information appliance is a hand-held information appliance.

4. The method of claim 1 further wherein:
said information appliance is an information appliance without a full-sized key board for entering alphanumeric text.

5. The method of claim 1 further comprising:
including in said results one or more links to access one or more data applications.

6. The method of claim 1 further comprising:
including in said results one or more interface indications allowing a user at said information appliance to modify data stored by said one or more data applications.

7. The method of claim 6 further wherein said one or more interface indications are selected from the group consisting of an HTML form and a rich client application.

8. The method of claim 7, wherein the rich client application is selected from the group consisting of:
an embedded rich client application;
a stand-alone rich client, which is native to the data application; and
a stand-alone third party rich client, which may or may not be created specifically for accessing the data stored by the data application.

9. The method of claim 8, wherein the rich client application is a Java™ applet;

10. The method of claim 1 further comprising:
including in said results one or more interface indications allowing a user to annotate data application records accessed by said server by storing comments that will be associated with said records but stored external to said record's associated data application.

11. The method of claim 1 further comprising:
including in said results one or more interface indications allowing a user to annotate data application records accessed by said server by storing linkage information between various data records, said linkage information stored external to said data applications.

12. The method of claim 1 further wherein:
said indicating allows indicating any portion of data as query data.

13. The method of claim 1 further wherein:
said indicating is performed by a user action.

14. The method of claim 1 further wherein:
said indicating may be configured to be performed automatically without specific user input.

15. The method of claim 1 further comprising:
enforcing multi-level security and/or access control at said relay server so that users only receive as results data for which said users are authorized.

16. The method of claim 1 further comprising:
executing a plurality of plug-ins at said relay server, each plug-in able to analyze said query data to determine if it is relevant to a particular data store and/or data application and to communicate with said particular data store and/or data application.

17. The method of claim 16 further comprising:
using said plurality of plug-ins to access a plurality of database applications using interfaces provided by said data applications, not requiring modification of said data applications.

18. The method of claim 16 further comprising:
using said plurality of plug-ins to access a plurality of data stores not requiring modification of said data stores.

19. The method of claim 16 further comprising:
using said plurality of plug-ins to access a plurality of data stores while not requiring said data to be imported to a different data application.

20. The method of claim 14 further comprising:
using said plurality of plug-ins and said relay server to enforce multi-level security and/or access control, thereby allowing control at a database, table, row, record, column, cell, area or object level, even when such control is not provided by a native data application.

21. A method of querying a number of data applications using an information appliance comprising:
receiving query data at a relay server;
making said query data available to a plurality of plug-in logic processes, each of said plug-in logic processes communicating with a main server process using a standard interface;
each of said plurality of plug-in logic processes analyzing said query data to determine if said data is possibly relevant to one or more data applications;
each of said plurality of plug-in logic processes formatting one or more requests to particular data applications;
wherein said requests in response to said query data;
wherein said requests are not necessarily related to one another;
wherein said requests are each formatted by said plug-in logic processes to correctly interact with specific data applications;
each of said plurality of plug-in logic processes transmitting requests to said data applications;
each of said plurality of plug-in logic processes receiving responses from said data applications;
each of said plurality of plug-in logic processes transmitting said responses to said main server process; and
compiling responses at said main server process into a compiled results report, said report potentially including unrelated responses.

22. The method of claim 21 further comprising:
presenting said results report to a user.

23. The method of claim 22 further comprising:
presenting at least one indication to a user allowing a user to request that one or more data items be modified.

24. The method of claim 22 further comprising:
presenting at least one indication to a user allowing a user to annotate said results report or a data item therein.

25. The method of claim 22 further comprising:
presenting at least one indication to a user allowing a user to create a linkage between two or more items in said results report.

26. The method of claim 21 further comprising:
using a definitive plug-in process to locate an item of data present in a data applications;

27. The method of claim 21 further comprising:
using a guessing plug-in process to return an indication of a data item that may not be known to any data application.

28. The method of claim 21 further comprising:
using a passing plug-in process to transfer a query or pre-processed query to a third party without trying to understand it or extract individual requests from it.

29. A computer readable medium containing computer interpretable instructions that when loaded into an appropriately configuration information processing device will cause the device to operate in accordance with the method of claim 21.

30. An information processing system able to provide flexible data handling throughout an enterprise comprising:
a plurality of clients executing on a plurality of information appliances;
a relay server able to communicate with two or more different data handling applications;
wherein said client allow indication of data presented from a variety of different logic applications at a client information appliance;
a communication medium interface allowing a client application to transmit query data to said relay server and receive results back from said server;
wherein said client and said server operate together to present a compilation report of results from a variety of different data applications, said results not necessarily related or derived from identical database application requests.
